(19) United States
(12) Patent Application Publication
(10) Pub. No.: US 2019/0034786 A1
(43) Pub. Date: Jan. 31, 2019

(54) System and Method for Making Nuclear Radiation Detection Decisions and/or Radionuclide Identification Classifications

(71) Applicant: James Ghawaly, JR., Knoxville, TN (US)

(72) Inventor: James Ghawaly, JR., Knoxville, TN (US)

(21) Appl. No.: 15/660,345

(22) Filed: Jul. 26, 2017

(51) Int. Cl. G06N 3/04; G06N 3/08; G01N 23/00

(52) U.S. Cl. CPC G06N 3/0472; G01N 23/00; G06N 3/08

(57) ABSTRACT

A method for detecting the presence and/or identity of a radionuclide including receiving data representing a time-correlated radiation count; processing said data in an artificial neural network; and indicating whether a radionuclide was detected and/or identifying the detected radionuclide.

A system for detecting the presence and/or identity of a radionuclide including a computer configured to receive data representing a time-correlated radiation count; the computer being configured to process the data in an artificial neural network; the computer configured to indicate whether a radionuclide was detected and/or identify the detected radionuclide.

### FIELD OF THE INVENTION

The invention relates generally to the detection and/or classification of radionuclides based on time-correlated radiation counting statistics and/or gamma-ray energy spectra with artificial neural networks.

### BACKGROUND OF THE INVENTION

As nuclear capable technologies become more accessible and easier to produce, it is important to improve the ability to detect and identify sources of nuclear radiation. Radiation detectors such as scintillators and semiconductor detectors provide the capability to detect gamma-rays and also determine their energy, but a human or computer must analyze the data and determine whether or not there is a source of radiation nearby and, if there is, what radionuclide or radionuclides comprise the detected source.

Because many radiation detectors are setup at border crossings, used in autonomous vehicles, or otherwise in a position where it is not realistic to have a human constantly monitoring the output, the data is instead recorded and analyzed on computers that are programmed using various algorithms to automatically detect and identify radionuclides based on the radiation counting statistics and/or gamma-ray energy spectra.

The most common method by which radiation detection decisions are made is to monitor the time-correlated radiation counts and trigger an alarm (“detection decision”) when the number of counts exceeds a user-defined threshold. This threshold is often defined as one or two standard deviations away from the mean number of counts detected for a specified length of time. This method is effective in most situations, but is prone to producing false-alarms when the local environment changes, or when the electronics in the radiation detector are subjected to an electrical noise-inducing source that leads to an increase in radiation counts, which are then falsely reported as a detected radionuclide.

Because each radionuclide (those that emit gamma-rays) emits gamma-rays of a specific energy or set of energies, it is possible to determine the identity of a radionuclide based on the peaks present on its gamma-ray energy spectrum. The gamma-ray energy spectrum is a type of time-correlated radiation counting where the energy or energies of the radiation is also detected. The two most common methods used to make identification decisions based on gamma-ray energy spectra are peak-fitting and Region-Of-Interest (ROI) analysis. The peak-fitting method can be described as consisting of two main processes. In the first process, a computer finds all of the peaks in the histogram, determines the energy of each peak, discards peaks that are associated with background and/or naturally occurring radiation, and maps the energy/energies of the other peak/peaks to a library of known gamma-ray energies to identify the associated radionuclides. In the second process, the identified radionuclides are sent to the operator as identification decisions. The ROI method is similar to the peak-fitting method, except, rather than looking at the number of radiation counts detected across all energies, the number of counts within a specific energy region-of-interest are analyzed. If the number of radiation counts in the ROI exceeds a user-specified threshold, then an identification decision is made. For example, if a user wanted to determine whether a detected radionuclide comprised a Cesium-137 source, the user could specify a ROI spanning from 660 to 664 kilo-electronvolts (keV) and analyze the counting statistics within this region of the gamma-ray energy spectrum. Both the peak-fitting and ROI methods of identification are highly prone to failure, as their accuracy and reliability is dependent on the integrity and smoothness of the data. In the event that there is significant radiation detected from sources other than those sought to be identified (e.g., noise), the “peaks” in the spectrum are small and non-uniformly distributed, in which case the algorithms often fail to make accurate or reliable identification decisions.

An artificial neural network is a computer model designed to simulate the brain, or at least how the brain is believed to work. An artificial neural network comprises one or more computation units termed perceptrons, which are loosely analogous to the neurons of the brain. Neurons are interconnected by synapses. Each synapse is believed to have an associated variable called the synaptic weight that scales the strength of signals that travel across that synapse. The output of each neuron is believed to be a function of the sum of the scaled signals arriving from the input synapses. Artificial neural networks and perceptrons operate in a similar manner.

An artificial neural network may comprise one or more layers of perceptrons, each of which comprise one or more perceptrons. The first layer of perceptrons is referred to as the “input layer,” and the last layer of perceptrons is referred to as the “output layer.” Layers of perceptrons existing in between the input layer and the output layer are referred to as “hidden layers.” An artificial neural network comprising more than one hidden layers is referred to as a “deep neural network.”

The perceptron is the computation unit of the artificial neural network. In general, a perceptron works as follows: The perceptron receives a data set comprising the output of one or more perceptrons from the previous layer. Each component of the data set is multiplied by a variable weight that scales the strength of that data set component based on the synapse from which the component was received. The output of a perceptron is a function of the sum of the products of the data components and their corresponding variable weights. The output may also be a function of a bias. The perceptrons of the input layer cannot receive data from previous layers of perceptrons. Instead, these perceptrons receive the data set to be analyzed. Each perceptron of the input layer may receive the entire data set, or more commonly, a portion of the data set to be analyzed. The output layer of perceptrons outputs one or more decisions based on the computation of the original data through the layers of perceptrons.

In order to train a neural network comprising one or more layers of perceptrons, a set of example inputs with known expected outputs, representative of the data that the neural network is expected to be presented, must first be found. This dataset is called the training set. The general process for training the network once a training set is made available is as follows: (1) For each input in the training set, send the inputs through the neural network, and record the output; (2) Calculate the error between the expected output and the actual output of the neural network; (3) Given the error, adjust the synaptic weights of each synaptic connection in the network, and also the biases of each perceptron, such that the error between actual and expected output is reduced—there are many methods of determining how to adjust the weights and/or biases, some common examples are: gradient descent, the backpropagation algorithm, and genetic training; and (4) Continue performing steps 1 through 3 for each input/expected output pair in the training set until the network is sufficiently trained.

### SUMMARY OF THE INVENTION

In various exemplary embodiments, the method for detecting the presence and/or identity of a radionuclide comprises receiving data representing time-correlated radiation counts; processing said data in an artificial neural network; and indicating whether a radionuclide was detected and/or indicating the identity of a detected radionuclide.

In various exemplary embodiments, the system for detecting the presence and/or identity of a radionuclide comprises a computer configured to receive data representing time-correlated radiation counts; the computer being configured to process the data in an artificial neural network; the computer configured to indicate whether a radionuclide was detected and/or indicating the identity of a detected radionuclide.

### BRIEF DESCRIPTION OF THE DRAWINGS

FIG. 1 shows a first embodiment of the invention.

FIG. 2 shows a component of the first embodiment of the invention.

FIG. 3 shows a component of the first embodiment of the invention.

### DETAILED DESCRIPTION OF THE INVENTION

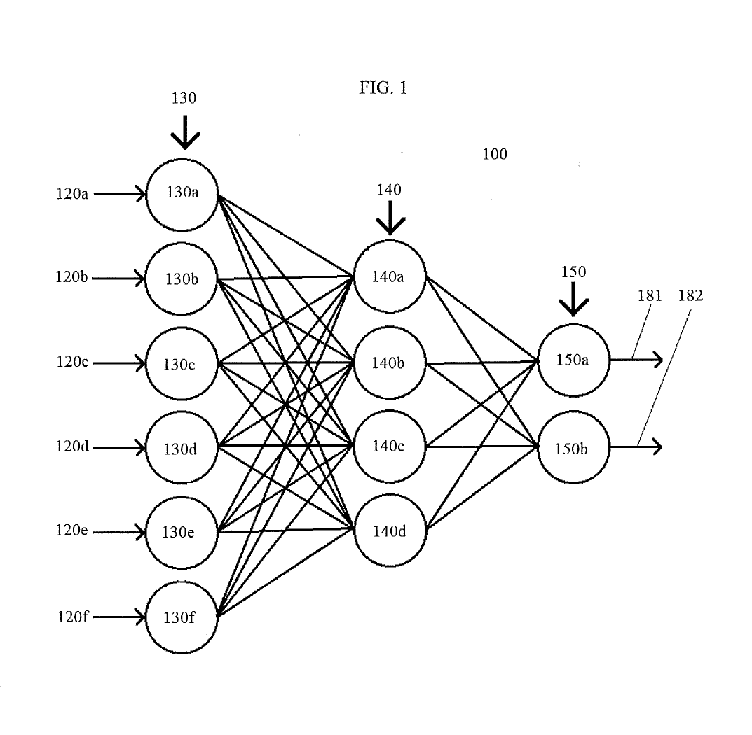

FIG. 1 shows a first embodiment of a neural network 100 of the present invention. In this embodiment, neural network 100 comprises a first layer of perceptrons 130, a second layer of perceptrons 140, and a third layer of perceptrons 150. The first layer of perceptrons 130 comprises inactive perceptrons 130a-f. The second layer of perceptrons 140 comprises active perceptrons 140a-d, and the third layer of perceptrons 150 comprises active perceptrons 150a-b. In this embodiment, a data set 120a-f, representing a time-correlated radiation count, is input into the first layer of perceptrons 130. In this embodiment, the time-correlated radiation count is a gamma-ray energy spectrum comprising data set components 120a to 120f. Each data set component represents the time-correlated radiation count in a defined energy range. The data set that comprises data set components 120a-f may be normalized prior to being input into the first layer of perceptrons 130. The data set components 120a-f may be input into the neural network 100 from a radiation detector in real-time. The data set components 120a-f may also be input into the neutral network 100 after the data set is collected and saved by the radiation detector and its associated data acquisition system.

The first layer of perceptrons 130 comprises perceptrons 130a-f. In this embodiment, perceptrons 130a-f are inactive. The second layer of perceptrons 140 comprises perceptrons 140a-d. The third layer of perceptrons 150 comprises perceptrons 150a-b. In this embodiment, the perceptrons 140a-d and the perceptrons 150a-b are active.

In this embodiment, the final output 181 of the neural network 100 is the calculated confidence that a first radionuclide has been detected. In this embodiment, the final output 182 of the neural network 100 is the calculated confidence that a second radionuclide has been detected.

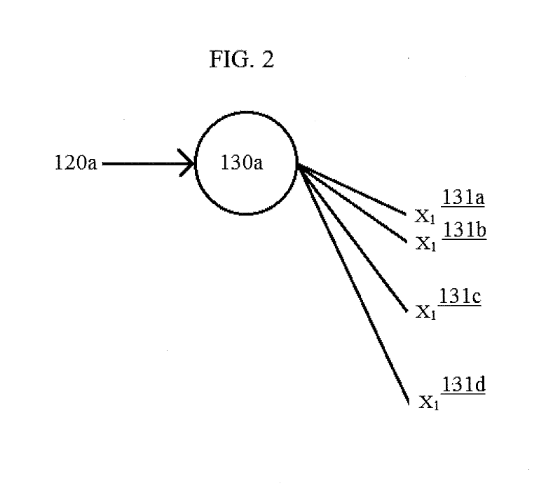

FIG. 2 shows the operation of the perceptron 130a of the first embodiment of the neural network 100. Perceptron 130a receives data set component 120a and outputs results 131a-d, each with the value X₁. The results 131a-d are sent to the second layer of perceptrons 140. In this embodiment, result 131a is sent to perceptron 140a, result 131b is sent to perceptron 140b, result 131c is sent to perceptron 140c, and result 131d is sent to perceptron 140d. The value of each of the results 131a-d, X₁, is the same. Further, because perceptron 130a is inactive, the value of the results 131a-d match the value of the data set component 120a. Perceptrons 130b-f of first layer of perceptrons 130 receive data set components 120b-f, respectively, and operate similarly to perceptron 130a.

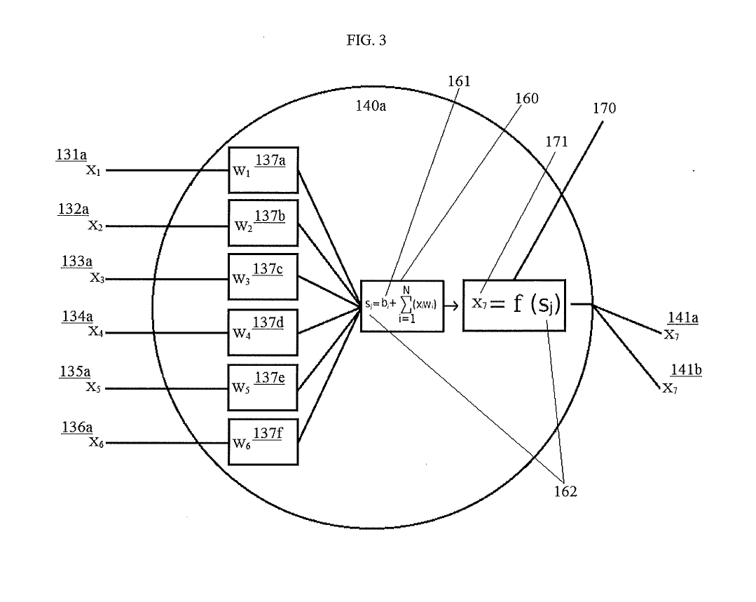

FIG. 3 shows the operation of perceptron 140a of the first embodiment of the neural network 100. Perceptron 140a receives result 131a from perceptron 130a, result 132a from perceptron 130b, result 133a from perceptron 130c, result 134a from perceptron 130d, result 135a from perceptron 130e, and result 136a from perceptron 130f. Perceptron 140a then sums up the products of the weights W₁ to W₆ 137a-f and the results X₁ to X₆ 131a-136a, respectively, according to the summation equation 160. In this embodiment, the summation equation 160 also includes a bias 161 (denoted bⱼ), which is also applied according to the summation equation 160. The result of the summation equation 160 is sⱼ 162, which is then input into activation function 170 (denoted f (sⱼ)). The activation function 170 is used to nonlinearly scale the output of the perceptron, because for a neural network to solve nonlinear problems, it must be able to produce a nonlinear decision boundary. Activation function 170 determines output X₇ 171, which is then transmitted to perceptrons 150a and 150b as inputs 141a and 141b, respectively. Perceptrons 140b-d of the second layer of perceptrons 140 and perceptrons 150a-b of the third layer of perceptrons 150 operate similarly to perceptron 140.

In alternative embodiments, the first layer of perceptrons 130 of neural network 100 is active and the perceptrons in the first layer of perceptrons operate similarly to perceptron 140a. In some embodiments, the neural network 100 may comprise two or more layers, with each layer having any number of perceptrons. In alternative embodiments of neural network 100, the layers of the neural network need not be precisely defined. In these embodiments, the outputs of one perceptron may travel directly to two or more perceptrons in different layers.

In the embodiment of neural network 100 discussed above, the decisions of the neural network are the confidence that a first radionuclide has been detected and the confidence that a second radionuclide has been detected, respectively. However, a vast array of other decision are possible. Such decisions include: whether any radionuclide was detected, whether a specific radionuclide was detected, whether a radionuclide within a user-defined list of radionuclides was detected, whether a naturally-occurring radionuclide was detected, and whether a non-naturally-occurring radionuclide was detected.

In still alternative embodiments, two or more neural networks may be used together. For example, in one embodiment a first neural network may be used to detect the presence of a radionuclide, and a second neural network may be used to identify the detected radionuclide and/or whether the detected radionuclide is background radiation. In some embodiments, the second neural network receives one or more outputs from the first neural network. Alternatively, a first system that does not comprise a neural network may be used to detect the presence of a radionuclide, and a second system comprising a neural network may be used to identify the detected radionuclide.

In additional alternative embodiments, a first neural network identifies one or more detected radionuclides. One or more outputs of the first neural network are input into a second neural network. The second neural network then determines whether to actuate an alarm indicating that a radionuclide was detected. The second neural network can actuate an alarm if the detected radiation is not background radiation, is a particular radionuclide(s), if the confidences that one or more radionuclides that were detected are above a certain level, for any number of other reasons, or for any combination of the foregoing.

1. A method for detecting the presence of a radionuclide comprising:
receiving data representing a radiation energy spectrum;
processing said data in a first artificial neural network comprising one or more perceptrons;
indicating whether a radionuclide was detected.

2. The method of claim 1, wherein the radiation energy spectrum is a gamma-ray energy spectrum.

3. The method of claim 1, wherein the first artificial neural network includes one or more hidden layers.

4. The method of claim 1, wherein the first artificial neural network is trained to differentiate between background radiation and other sources of radiation.

5. The method of claim 1, wherein a second artificial neural network identifies a detected radionuclide, the second artificial neural network receiving one or more outputs of the first artificial neural network.

6. The method of claim 1, wherein the first artificial neural network determines a confidence that the radionuclide was detected.

7. The method of claim 6, wherein one or more outputs of the first artificial neural network are input into a second artificial neural network, the second artificial neural network determining whether to activate an alarm.

8. The method of claim 2, wherein the first artificial neural network identifies one or more detected radionuclides.

9. A system for detecting the presence of a radionuclide comprising:
a computer configured to receive data representing a radiation energy spectrum;
the computer being configured to process the data in a first artificial neural network comprising one or more perceptrons;
the computer configured to indicate whether a radionuclide was detected.

10. The system of claim 9, wherein the computer is configured to receive data representing a gamma-ray energy spectrum.

11. The system of claim 9, wherein the first artificial neural network includes one or more hidden layers.

12. The system of claim 9, wherein the first artificial neural network determines the confidence that the radionuclide was detected.

13. The system of claim 9, wherein the first artificial neural network is trained to differentiate between background radiation and other sources of radiation.

14. The system of claim 9, wherein the first artificial neural network is capable of identifying one or more detected radionuclides.

15. The system of claim 9 further comprising a second neural network that identifies a detected radionuclide, wherein the second neural network receives one or more outputs from the first neural network.

16. A method for detecting the presence of a radionuclide comprising:
receiving data representing time-correlated radiation counting statistics;
processing said data in a first artificial neural network comprising one or more perceptrons;
indicating whether a radionuclide was detected.

17. The method of claim 16, wherein the first artificial neural network includes two or more hidden layers.

18. The method of claim 16, wherein the first artificial neural network is trained to differentiate between background radiation and other sources of radiation.

19. The method of claim 16, wherein the first artificial neural network determines the confidence that a radionuclide was detected.

20. The method of claim 16, wherein a second artificial neural network identifies a detected radionuclide, the second artificial neural network receiving one or more outputs from the first artificial neural network.
